(19) United States
(12) Patent Application Publication
(10) Pub. No.: US 2010/0017743 A1
(43) Pub. Date: Jan. 21, 2010

(54) Graphical User Interface

(75) Inventor: Neil Swanston, Edinburgh (GB)

Correspondence Address: HARNESS, DICKEY & PIERCE, P.L.C., P.O. BOX 828, BLOOMFIELD HILLS, MI, 48303, US

(73) Assignee: EMERSON NETWORK POWER - EMBEDDED COMPUTING, INC., Madison, WI (US)

(21) Appl. No.: 12/486,792

(22) Filed: Jun. 18, 2009

Related U.S. Application Data
(60) Provisional application No. 61/074,082, filed on Jun. 19, 2008.

(51) Int. Cl. G06F 3/048

(52) U.S. Cl. 715/781

(57) ABSTRACT

A system and method for providing a graphical representation of a computer device and display overlay is disclosed. A computer device is represented in a graphical representation. The computer device comprises at least two modules. An overlay comprising at least one attribute corresponding to each of the modules is positioned such that the attributes are spatially associated with the modules corresponding thereto.

### CROSS-REFERENCE TO RELATED APPLICATIONS

This application claims the benefit of U.S. Provisional Application No. 61/074,082, filed on Jun. 19, 2008. The disclosure of the above application is incorporated herein by reference.

### FIELD

The present disclosure relates to computer device management products and a system and method of providing a graphical display of a computer device to a user.

### BACKGROUND

The statements in this section merely provide background information related to the present disclosure and may not constitute prior art.

There exists a number of computer device management programs that provide a depiction of the computer device that is being managed. In these programs, a representation of the computer device is typically presented in a graphical user interface. A user of these management programs may interact with the graphical user interface by, for example, utilizing a keyboard, mouse, or other input device. The user interaction typically involves an attempt to diagnose an issue or problem with the computer device by monitoring the operation parameters or attributes of the computer device. Often, a user must diagnose a problem with the computer device on a general level, and then later determine which of the number of particular modules or components of the computer device is experiencing the error. The problems are usually presented to the user in text format, e.g., a statement stating the issue to be resolved and the location in the computer device where the problem is located, or with a visual indication, both of which being removed from the representation of the device.

In both cases, the user then must translate the location identified in the text statement or visual indication to an actual physical location in the physical device to resolve the issue. Often times, the translation between the location identified by the text statement or visual indication and the physical location in the device is non-intuitive and the user must possess specialized knowledge of the device. It would be desirable for the computer management product to provide a more intuitive presentation of the issue to the user.

### SUMMARY

The disclosure addresses the above-identified issue by providing a system and method for providing an overlay upon a graphical representation of a computer device.

In some features, the present disclosure provides a graphical display system for presenting attributes of a computer device to a user. The system comprises a graphical representation of a computer device and a display overlay. The computer device comprises at least two modules, which are displayed in the graphical representation. Additionally, the display overlay comprises at least one attribute corresponding to each of the modules. Further, the overlay is positioned such that each of the attributes is spatially associated with its corresponding module.

In various features, the present disclosure relates to a method for presenting attributes of a computer device to a user. The method comprises representing a computer device on a display to obtain a graphical representation of the computer device, and displaying an overlay on the graphical representation. The computer device comprises at least two modules. Additionally, the overlay comprises at least one attribute corresponding to each of the modules. Further, the overlay is positioned with respect to the graphical representation such that each of the attributes is spatially associated with its corresponding module.

In still other features, the systems and methods described above are implemented by a computer program executed by one or more processors. The computer program can reside on a computer readable medium such as but not limited to memory, nonvolatile data storage, and/or other suitable tangible storage mediums.

Further areas of applicability of the present disclosure will become apparent from the detailed description, the claims and the drawings. It should be understood that the detailed description and specific examples are intended for purposes of illustration only and are not intended to limit the scope of the disclosure.

### DRAWINGS

The drawings described herein are for illustration purposes only and are not intended to limit the scope of the present disclosure in any way.

FIG. 1 is an illustration of a graphical user interface according to some embodiments of the present disclosure;

FIG. 2 is an illustration of a graphical user interface with a graphical overlay according to various embodiments of the present disclosure;

FIG. 3 is an illustration of a graphical user interface with a graphical overlay according to some embodiments of the present disclosure;

FIG. 4 is an illustration of a graphical user interface with a graphical overlay according to various embodiments of the present disclosure; and

FIG. 5 is an illustration of a graphical user interface with a graphical overlay according to some embodiments of the present disclosure.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure is directed to a graphical user interface 10 that intuitively links performance attributes of the modules of a computer device with a graphical overlay such that the user can quickly and easily monitor any or all of the attributes of the computer device.

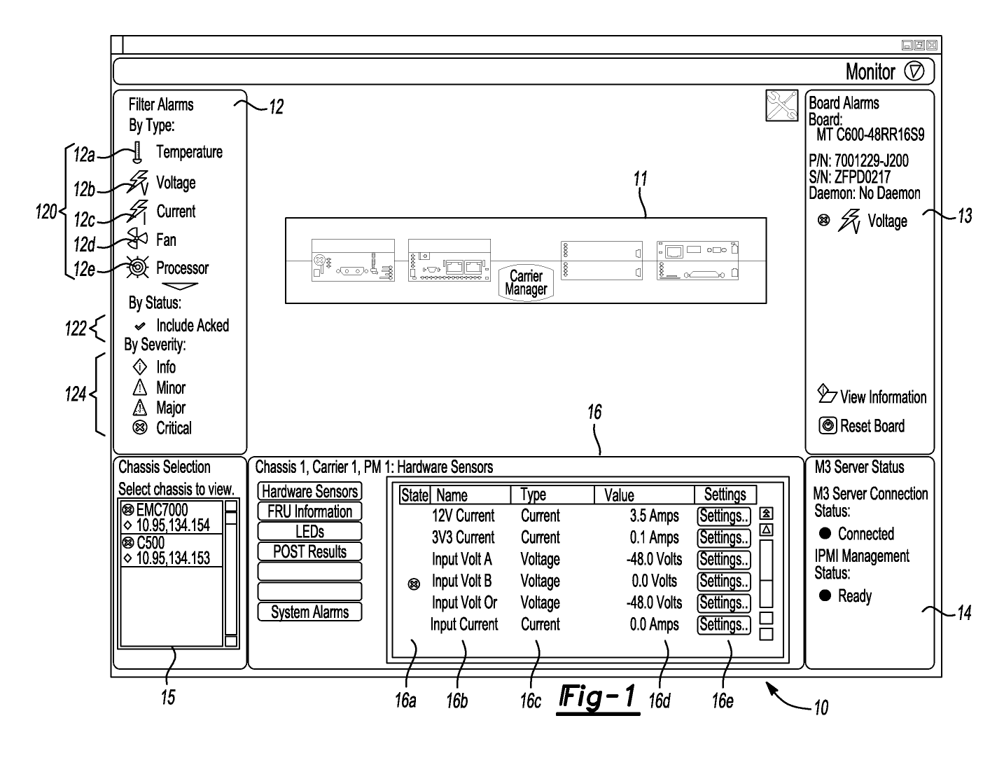

Referring now to FIG. 1, a graphical user interface 10 according to some embodiments of the present disclosure is illustrated. Graphical user interface 10 comprises a graphical representation of a computer device 11, an indicator legend portion 12, an alarm status portion 13, a server status portion 14, a selection portion 15, and attribute display portion 16. The graphical representation of computer device 11 is either a 3D or 2D visual representation of the computer device. In the example illustrated in FIG. 1, the graphical representation of computer device 11 comprises one chassis of a multi-chassis computer rack, for example, a server. Alternatively, the graphical representation of computer device 11 may show all of the chassis of a server, or any number of the chassis. A user may select which portion of the computer device that will be displayed, for example, by selecting the appropriate component/chassis in selection portion 15.

The indicator legend portion 12 of the graphical user interface 10 comprises a plurality of graphical icons 12a-12e that identify the type of indication to be presented to a user. Further, the graphical icons 12a-12e of indicator legend 12 may also indicate the importance of the indicator, the time duration of the specific indication, or any other useful information that will be illustrated in the graphical user interface 10. In the illustrated example of FIG. 1, the indicator legend 12 includes icons relating to filter alarms 120, as well as indication of the status 122 of the alarm and the severity 124 of the alarm.

Selection portion 15 may comprise a list of available components or chassis of the computer device that will be displayed in the graphical representation 11. Selection portion 15 may also provide a graphical representation of the computer device in a smaller format, with which the user could interact to select the component of the computer device that will be shown in graphical representation 11. In the illustrated example, there are two different server chassis that may be displayed, of which one is displayed in graphical representation 11. A user may select, through interaction with selection portion 15, to display one, a subset of, or all of the components of the computer device to be displayed. In some embodiments, selection portion 15 could be combined with the graphical representation of the computer device 11 such that a user could interact directly with the graphical representation 11, for example, by pointing and clicking with a mouse on the chassis of interest.

The server status portion 14 provides an indication of the connection status between the management program and the computer device. The status indicated in server status portion 14 differs from that of alarm status 13 in that server status portion 14 merely indicates the status and wellbeing of the connection to the computer device. Server status portion 14 does not, for example, indicate any operating issues of the computer device, except that it shows when the computer device or a connection thereto has failed.

The attribute display portion 16 of graphical user interface 10 lists, or provides a visual presentation of, all of the operating attributes of the computer device. In the illustrated example, the attribute display portion 16 lists the operating parameters or attributes of the chassis that is selected in selection portion 15 and illustrated in graphical representation 11. The attribute display portion 16 in the illustrated example includes a table with a number of columns 16a-16e. The rows of this table comprise the specific operating parameters or attributes to be displayed. Column 16a indicates the state of the operating attribute and will indicate a fault or alarm relating to an attribute. Column 16b indentifies the name of the attribute being monitored. Column 16c indicates the type of the attribute being monitored, while column 16d indicates the value of the attribute. In the illustrated example, additional column 16e is provided for manipulating the settings of the specific attribute by means of a “settings” button. The amount, type and organization of the columns may differ and still fall within the scope of this disclosure.

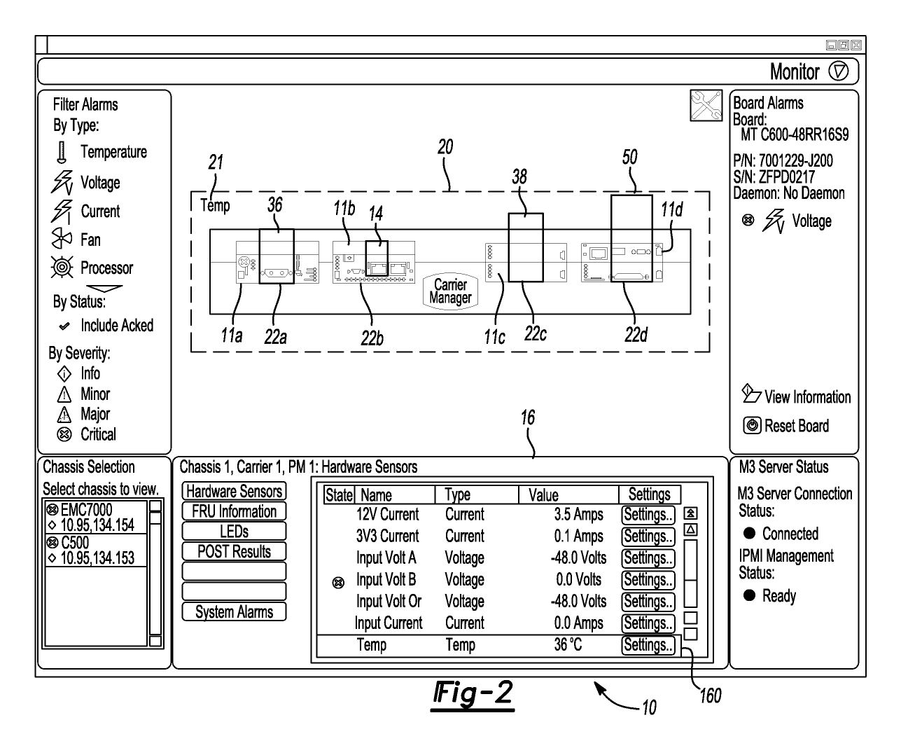

Referring now to FIG. 2, a graphical user interface 10 with an associated display overlay 20 according to various embodiments of the present disclosure is illustrated. Display overlay 20, or portions of the display overlay 20, may be toggled on and off by a user. In this manner, a user may be presented with the graphical representation of computer device 11 of FIG. 1 or, upon selection of graphical overlay 20, the combination of graphical representation of the computer device 11 with overlay 20.

Graphical overlay 20, as illustrated in FIG. 2, comprises an attribute identifier 21 and attribute display portions 22a-22d. Attribute identifier 21 provides an indication of which attribute the overlay 20 is currently presenting to the user. Attribute identifier 21 may, for example, comprise one of the graphical icons 12a-12e discussed above. Alternatively, attribute identifier 21 may be a textual indication of the attribute, or a textual indication combined with graphical icon 12a-12e. Attribute display portions 22a-22d in the illustrated example comprise bar graphs representing the measured value of the attribute being displayed. With specific reference to the attribute illustrated in FIG. 2, attribute identifier 21 comprises a graphical icon indicating that the temperature of the modules is being monitored. Attribute displays portions 22a-22d comprise bar graphs, which may be provided in multi-color format, as well as a numerical indication of the measured temperature value. Each of the attribute display portions 22a-22d corresponds to one of the modules 11a-11d of graphical representation of computer device 11. The corresponding nature of the attribute display portions to the modules is indicated by a spatial association, for example, attribute display portions 22a-22d are present directly above modules 11a-11d in the illustrated example of FIG. 2. Alternative forms of spatial associations may be utilized, such as, but not limited to, lines connecting attribute display portions 22a-22d to their corresponding modules 11a-11d. In attribute display portion 16, row 160, which is temperature of the modules, may be highlighted to indicate which of the attributes is shown in graphical overlay 20.

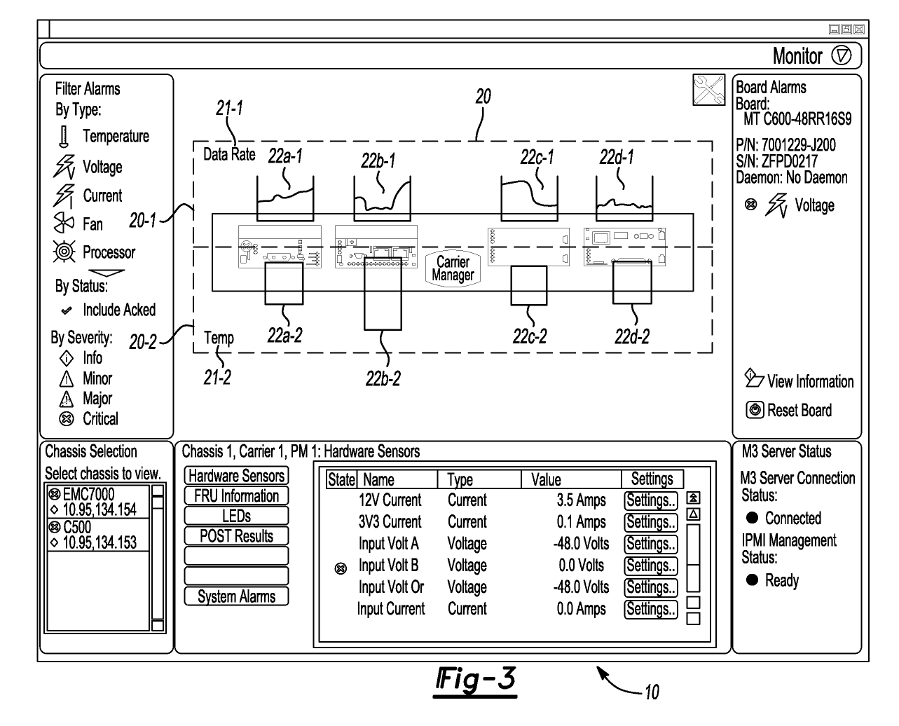

As illustrated in FIG. 3, graphical overlay 20 may be subdivided into various different portions, for example, portions 20-1 and 20-2. In this manner, a plurality of attributes may be presented in one graphical overlay 20. In the illustrated example, graphical overlay portion 20-1 provides a visual indication of the data rate of modules 11a-11d, while graphical overlay portion 20-2 provides a visual indication of the temperature of modules 11a-11d. Attribute display portions 22a-1 to 22d-1 comprise line graphs that graphically illustrate the attribute of data rate through modules 11a-11d, respectively. Attribute display portions 22a-2 to 22d-2 comprise bar graphs illustrating the temperature of modules 11a-11d, respectively. In this manner, a user may select and monitor multiple attributes through display overlay 20.

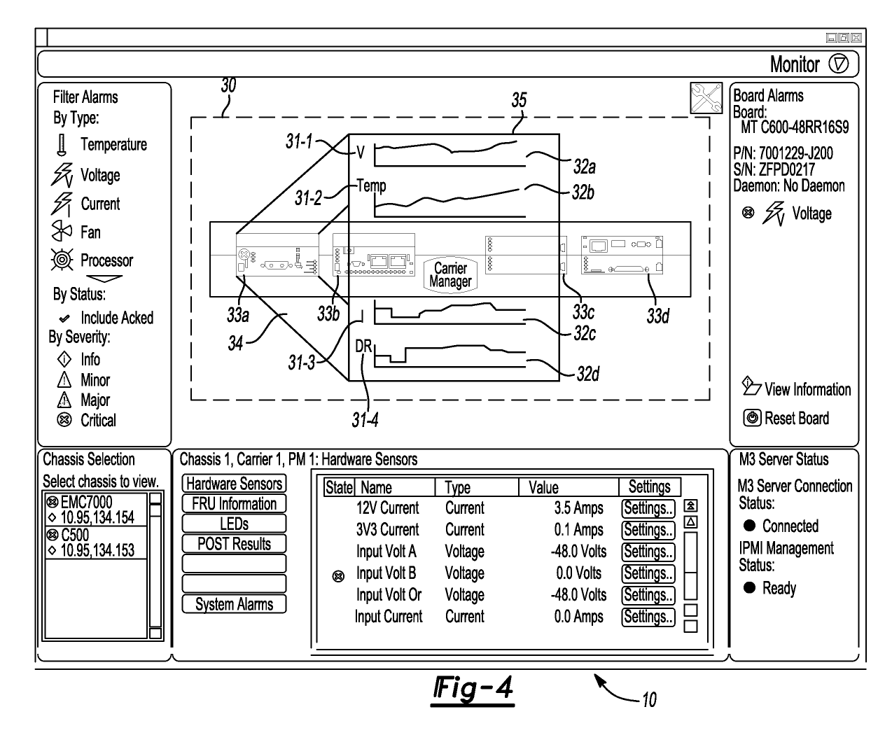

Referring now to FIG. 4, a graphical user interface 10 according to some embodiments of the present disclosure is illustrated. Graphical overlay 30 in FIG. 4 differs from the graphical overlays 20 in FIGS. 2 and 3 in that only a portion of the attributes associated with the computer device is presented at one time. In the illustrated example, graphical overlay 30 includes a comprehensive attribute display 35 that corresponds with module 33a of the computer device. The comprehensive attribute display 35 is spatially associated with module 33a by use of spatial association indicator 34. In the illustrated example, spatial association indicator 34 comprises lines and shaded portions linking module 33a with attribute display 35, although different forms of spatial associations or spatial association indicators may be used. Comprehensive attribute display 35, in the illustrated example, identifies four different attributes of module 33a, specifically, voltage 32a, temperature 32b, current 32c, and data rate 32d. These attributes are identified by attribute identifiers 31-1 to 31-4, respectively. The specific format illustrated in FIG. 4 of attribute display portions 32a-32d are line graphs indicating a value of the attribute versus time, although other forms of display and/or graphs may be utilized. In this embodiment, a user presented with graphical user interface 10 may monitor all of the attributes associated with a particular module 33a of a computer device at one time, and thus monitor the modules 33a-33d of the computer device separately. Alternatively, the graphical overlay 30 may display comprehensive attribute displays for each and every module 33a-33d of the computer device. It is contemplated that the graphical overlay 30 include all of the comprehensive attribute displays 35, or all of the attribute display portions 22a-22d, for every module 11a-11d, 33a-33d even when only a subset of these attribute display portions are displayed to a user. Thus, display overlays 20, 30 are said to include attributes corresponding to each of the modules even in the event that only a portion of the these attributes are displayed to a user at any one time.

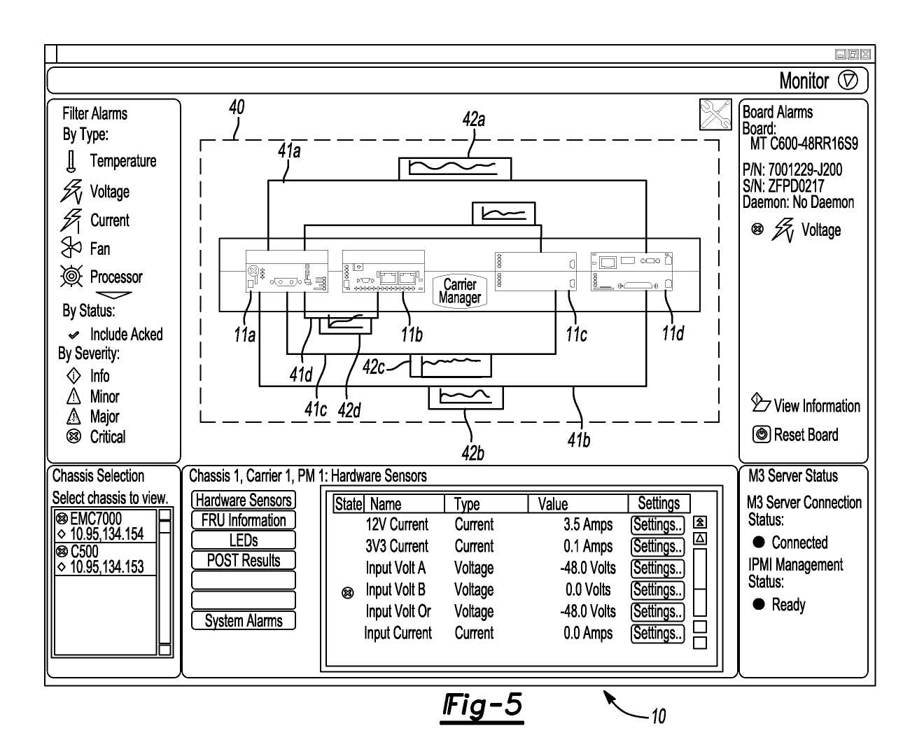

Referring now to FIG. 5, a graphical user display 10 according to some embodiments of the present disclosure is illustrated. In this example, graphical overlay 40 displays to a user a plurality of connections 41 between modules 11a-11d of the computer device. These connections 41a through 41d are shown to link the modules that are connected, although multiple module connections, for example, one connecting modules 11a to 11b to 11c (not shown), may also be displayed. Graphical overlay 40 may also include attribute display portions 42a through 42d associated with connections 41a to 41d, respectively. These attribute display portions 42a-42d may, for example, display specific attributes of the connections 41a to 41d to which they are associated. In the illustrated example in FIG. 5, attribute display portions 42a-42d comprise a line graph of data rate versus time for the connections 41a to 41d, although other attributes would fall within the scope of this disclosure.

In some embodiments of the present disclosure, the graphical overlays 20, 30, 40 and all of their associated portions are semi-transparent. Furthermore, the graphical overlays 20, 30, 40 of the present disclosure may be positioned such that the attribute display portions, for example elements 22, 32 and 42, are present over the modules 11a-11d, 33a-33d to which they are associated. In various embodiments, the graphical overlays of the present disclosure include attribute display portions 22a-22d, 32a-32d, and 42a-42d that are not present over their associated modules, but instead are otherwise spatially associated therewith. Additionally, attribute display portions 22, 32, 42, may comprise one of, or a combination of, a bar graph format, a contour map format, a line graph format, a numerical or textual indication of the value of the attribute, or any other format. For example, with respect to FIG. 2, which indicates the temperature of the modules 11a-11d of the computer device, attribute display portions 22a-22d comprise both a bar graph and an associated numerical value indicating the temperature of the modules 11a-11d, respectively. It is also contemplated that any attribute of the computer device may be displayed by the graphical user interface 10 and its associated graphical overlay 20, 30, 40 of the present disclosure, specifically including, but not limited to, the temperature, voltage, current, power rating and data rate of a module.

The graphical user interface 10 of the present disclosure may be implemented such that a user may selectively display portions of the graphical overlays 20, 30, 40 by, for example, interaction with a computer associated with the display on which the graphical user interface 10 is presented. In some embodiments, a user may toggle through various display modes of the graphical overlay 20, 30, 40 by use of hot keys on a keyboard. Alternatively, or in addition to hot keys, a user may toggle through display modes of the graphical overlay 20, 30, 40 by a mouse or any other computer input device.

Those skilled in the art can now appreciate from the foregoing description that the broad teachings of the present disclosure can be implemented in a variety of forms. Therefore, while this disclosure has been described in connection with particular examples thereof, the true scope of the disclosure should not be so limited since other modifications will become apparent to the skilled practitioner upon a study of the drawings, specification and following claims.

What is claimed is:

1. A graphical display system for presenting attributes of a computer device to a user, comprising:
a graphical representation of a computer device that comprises at least two modules; and
a display overlay comprising at least one attribute corresponding to each of the at least two modules, the overlay being positioned such that each of the attributes is spatially associated with its corresponding module.

2. The system of claim 1, wherein the display overlay is removable.

3. The system of claim 1, wherein the display overlay is semi-transparent.

4. The system of claim 1, wherein the at least one attribute is presented in a bar graph format, a contour map format or a line graph format.

5. The system of claim 1, wherein the at least one attribute comprises a module temperature, a module voltage, a module current, a power rating or a module data rate.

6. The system of claim 1, wherein the at least one attribute comprises a connectivity map illustrating at least one connection between a first of the at least two modules and a second of the at least two modules.

7. The system of claim 6, wherein the connectivity map comprises a data rate for the at least one connection.

8. The system of claim 1, wherein the display overlay is partially removable such that a subset of the attributes is displayed.

9. The system of claim 8, wherein a user selects the subset of the attributes.

10. The system of claim 8, wherein the at least one attribute comprises a connectivity map illustrating at least one connection between a first of the at least two modules and a second of the at least two modules.

11. A method for presenting attributes of a computer device to a user, comprising:
representing a computer device on a display to obtain a graphical representation of the computer device, wherein the computer device comprises at least two modules; and
displaying an overlay on the graphical representation, wherein the overlay comprises at least one attribute corresponding to each of the at least two modules, the overlay being positioned with respect to the graphical representation such that each of the attributes is spatially associated with its corresponding module.

12. The method of claim 11, wherein the overlay is removable.

13. The method of claim 11, wherein the overlay is semi-transparent.

14. The method of claim 11, wherein the at least one attribute is presented in a bar graph format, a contour map format or a line graph format.

15. The method of claim 11, wherein the at least one attribute comprises a module temperature, a module voltage, a module current, a power rating or a module data rate.

16. The method of claim 11, wherein the at least one attribute comprises a connectivity map illustrating at least one connection between a first of the at least two modules and a second of the at least two modules.

17. The method of claim 16, wherein the connectivity map comprises a data rate for the at least one connection.

18. The method of claim 11, wherein the overlay is partially removable such that a subset of the attributes is displayed.

19. The method of claim 18, wherein a user selects the subset of the attributes.

20. The method of claim 18, wherein the at least one attribute comprises a connectivity map illustrating at least one connection between a first of the at least two modules and a second of the at least two modules.

21. A computer program stored on a tangible medium for presenting attributes of a computer device to a user, comprising:
representing a computer device on a display to obtain a graphical representation of the computer device, wherein the computer device comprises at least two modules; and
displaying an overlay on the graphical representation, wherein the overlay comprises at least one attribute corresponding to each of the at least two modules, the overlay being positioned with respect to the graphical representation such that each of the attributes is spatially associated with its corresponding module.

22. The computer program of claim 21, wherein the overlay is removable.

23. The computer program of claim 21, wherein the overlay is semi-transparent.

24. The computer program of claim 21, wherein the at least one attribute is presented in a bar graph format, a contour map format or a line graph format.

25. The computer program of claim 21, wherein the at least one attribute comprises a module temperature, a module voltage, a module current, a power rating or a module data rate.

26. The computer program of claim 21, wherein the at least one attribute comprises a connectivity map illustrating at least one connection between a first of the at least two modules and a second of the at least two modules.

27. The computer program of claim 26, wherein the connectivity map comprises a data rate for the at least one connection.

28. The computer program of claim 21, wherein the overlay is partially removable such that a subset of the attributes is displayed.

29. The computer program of claim 28, wherein a user selects the subset of the attributes.

30. The computer program of claim 28, wherein the at least one attribute comprises a connectivity map illustrating at least one connection between a first of the at least two modules and a second of the at least two modules.
